(19) United States
(12) Patent Application Publication
(10) Pub. No.: US 2026/0365537 A1
(43) Pub. Date: Nov. 19, 2026

(54) METHOD FOR UPCYCLING CATHODIC MATERIALS FROM A SPENT BATTERY TO ELECTROCHEMICAL CATALYSTS

(71) Applicant: City University of Hong Kong, Hong Kong (HK)

(72) Inventors: Jian WANG, Hong Kong (HK); Jia LEI, Hong Kong (HK); Yixiao HUANG, Hong Kong (HK)

(21) Appl. No.: 19/674,138

(22) Filed: May 12, 2026

Related U.S. Application Data
(60) Provisional application No. 63/805,295, filed on May 14, 2025.

(51) Int. Cl. C01G 53/42; H01M 10/54

(52) U.S. Cl. CPC C01G 53/42; H01M 10/54; C01P 2002/54; C01P 2006/40

(57) ABSTRACT

An upcycling method for converting LiCoO₂ materials recovered from spent lithium- ion batteries into LiCoNiFePd electrocatalysts for anion exchange membrane water electrolysis is disclosed. The method comprises separating and purifying LiCoO₂ from spent batteries, doping with Ni, Fe, and Pd to form LiCoNiFePd catalysts; milling the catalysts to reduce particle size and performing plasma treatment to enhance surface activity. An anode catalyst ink is prepared using LiCoNiFePd catalysts; and the ink is spray-coated onto nickel foam at an elevated temperature to form an integrated anode-gas diffusion layer for constructing an anion exchange membrane water electrolysis cell. The disclosed approach integrates battery material recycling with electrocatalyst fabrication, providing a sustainable pathway for transforming waste LiCoO₂ into functional oxygen evolution catalysts for water electrolysis systems.

### CROSS-REFERENCE TO RELATED APPLICATIONS

The present application claims priority from the United States Provisional Patent Application No. 63/805,295 filed May 14, 2025, and the disclosure of which is incorporated herein by reference in its entirety.

### FIELD OF THE INVENTION

The present invention generally relates to battery recycling technologies. More specifically the present invention relates to a method for upcycling spent battery cathode materials into water splitting electrocatalysts for green hydrogen production.

### BACKGROUND OF THE INVENTION

The wide adoption of portable electronic devices and electric vehicles has resulted in a notable demand for recycling spent lithium-ion batteries. Concurrently, the global initiative of striving for carbon neutrality has underscored the pressing necessity for cost-effective and efficient technologies for green hydrogen production, which remain underdeveloped.

Lithium-ion batteries (LIBs) are a crucial component of the global energy transition, driving the rapid growth of demand in electric vehicles and renewable energy storage. The main LIB cathode materials are layered oxides, including LiCoO₂ (LCO), LiNiₓMn_{y}Co_{z}O₂ (NMC), LiNiCoAlO₂ (NCA), and others. The recycling of spent LIBs is of great importance for the recovery of valuable metals (e.g., cobalt and lithium) and the mitigation of environmental pollution. The most common recycling approaches include direct recycling, pyrometallurgy, hydrometallurgy, biohydrometallurgy (bioleaching), and electrometallurgy.

The principal strategy of direct recycling entails the reactivation of active electrode materials in spent batteries, thereby restoring capacity and mitigating performance loss that occurs during the recycling process. The process comprises several stages, including discharging, dismantling, electrolyte recovery, separation of electrode materials or metals, and regeneration of electrode materials. The principal regeneration techniques for cathode materials encompass solid-phase reaction, hydrothermal treatment, coprecipitation, sol-gel, and carbothermal reduction. Nevertheless, challenges such as impurity removal, high energy consumption, and intricate reactions persist. Moreover, its implementation is currently constrained to laboratory settings due to the complexity of the preprocessing procedures and the utilization of toxic reagents.

Extensive development has been observed in the field of pyrometallurgy, a widely adopted extractive metallurgy technology, regarding the recycling of spent LIBs. Conventional pyrometallurgical techniques (e.g., direct roasting) entail the conversion of diverse components within LIBs (cathode, anode, binder, separator, and electrolyte) into cobalt-bearing alloys, slag, and gases at elevated temperatures exceeding 1000 °C. Hydrometallurgy has been employed extensively for the recovery of valuable LIB components using aqueous solutions, including acids. Nevertheless, the utilization of potent acids and the management of liquid waste present significant sustainability challenges. Bioleaching employs the use of acidophilic microorganisms, which may be bacteria or fungi, to facilitate the extraction of metals under controlled conditions. The efficiency of bioleaching is influenced by several factors, including pH, temperature, the type and source of nutrients, and pulp density. While bioleaching offers numerous environmentally friendly advantages, the slow kinetics and selective metal dissolution processes present significant challenges that require further investigation and optimization. Electrometallurgy, which encompasses processes such as electrodeposition, electrowinning, electrorefining, and electroplating, is garnering attention as a means of recycling LIBs due to its reduced reliance on external reagents.

The United States Patent No. 6,511,639 outlines a methodology for the recovery of negative-electrode materials from spent lithium batteries, with a particular emphasis on lithium/transition metal mixed oxides. The method comprises the following steps: The process comprises the following steps: (i) uncovering the electrode pack, (ii) organic solvent extraction, (iii) drying, (iv) mechanical separation of positive electrodes, (v) grinding and classification, and (vi) high-temperature treatment (300–700 °C) to eliminate non-electrode residues. The United States Patent Publication No. 20220376312A1 delineates sophisticated methodologies for the recycling and regeneration of lithium-ion battery cathode materials, with a particular emphasis on LCO and NCM chemistries. The proposed techniques combine hydrothermal treatment and thermal annealing to restore cathode material performance, emphasizing the environmental and economic benefits over traditional recycling methods. It is regrettable that these methods of recycling metals from spent LIBs tend to be energy-intensive and carry a substantial environmental footprint. Furthermore, the regenerated electrode materials frequently fail to meet the requisite commercial-grade standards for battery use. This is because, firstly, particles of these materials are too large to offer sufficient surface area for high-activity reactions. In the second place, layered lithium transitional metal oxides do not have very high activities in water-splitting reactions. It is therefore imperative that environmentally friendly and efficient LIB recycling processes be developed as a matter of urgency.

Anion Exchange Membrane Water Electrolysis (AEMWEs) is emerging as a promising technology in the field of hydrogen production. It is a promising solution in the context of global efforts to transition away from traditional fossil fuels and address climate change, due to its cleanliness and environmental friendliness. The fundamental configuration of an AEMWE cell comprises an anion exchange membrane (AEM) and two catalytic electrodes. Typically, AEMWE employs dilute alkaline solutions or pure water as electrolytes, along with inexpensive non-precious metal catalysts and carbon-based membranes. During operation, water is subjected to electrolysis, resulting in the generation of hydrogen and oxygen gases. Nevertheless, the current state of water electrolysis technology remains constrained by the suboptimal performance of electrocatalysts. The efficiency of these catalysts has a significant impact on electricity consumption, which constitutes a considerable portion (approximately 70% to 90%) of the total cost of hydrogen generation. Furthermore, their durability determines the lifespan of water electrolyzers. It is therefore imperative that the development of high-performance, cost-effective electrocatalysts be pursued as a matter of urgency if the goal of economical and efficient green hydrogen production via water electrolysis is to be achieved.

Transition metal oxides, hydroxides, and phosphates have been identified as common catalysts for water splitting. Those based on Fe, Co, and Ni have been found to exhibit favorable electronic structures and stability in alkaline environments, making them promising candidates for this process. Additionally, lithium-containing transition metal oxides (LTMOs), including LiCoO₂, NMC, and NCA, have been the subject of considerable interest as electrocatalysts for water splitting, particularly for the oxygen evolution reaction.

Among the various cobalt oxides, layered LCO is of particular interest due to the facile tunability of its cobalt redox and associated lithium composition. In addition, the abundant availability of LCO from spent lithium-ion batteries makes it an appealing material for recycling and repurposing in other energy applications. Nevertheless, the intrinsic oxygen evolution reaction (OER) activity of LCO is limited due to the substantial potential barrier that must be overcome to trigger its favorable surface reconstructions. To enhance its activity, several strategies have been employed, including elemental doping, exfoliation, cation insertion, and electrochemical tuning. However, none of these strategies have yielded a high-performance and durable OER electrocatalyst for practical electrolyzer applications. Accordingly, further advances are needed to lower the overpotential, enhance stability under high current densities, and develop scalable synthesis routes that preserve catalytic performance.

### SUMMARY OF THE INVENTION

In accordance with one aspect of the present invention, a method is provided for upcycling cathodic materials from a spent battery to electrochemical catalysts. The method comprises: separating the cathodic materials from the spent battery; purifying the cathodic materials; doping the cathodic materials with one or more additives to obtain the electrochemical catalysts; milling the electrochemical catalysts to reduce particle sizes of the electrochemical catalysts; and performing plasma treatment on the electrochemical catalysts to increase surface activities of the electrochemical catalysts.

In one embodiment, the spent battery is a lithium-ion battery; and the cathodic materials are LiCoO₂.

In one embodiment, the LiCoO₂ materials are doped with Ni, Fe and Pd such that the electrochemical catalysts are LiCoNiFePd catalysts.

In one embodiment, the LiCoO₂ materials are doped with Ni, Fe and Pd by: mixing the LiCoO₂ materials with Fe₂O₃ _{,} NiO and Pd(NO₃)₂ to form a mixture; and sintering the mixture in ambient air to form the LiCoNiFePd catalysts.

In one embodiment, sintering the mixture is performed by heating the mixture from ambient temperature to a sintering temperature with a heating ramping rate in a range of 5 to 10 ºC min⁻¹ and the sintering temperature is in a range of 700 to 850 ºC such that the LiCoNiFePd catalyst has a composition of LiCo_{0.79}Ni_{0.1}Fe_{0.1}Pd_{0.01}O₂ anda layered structure.

In one embodiment, the method further comprises soaking the spent battery in a saturated NaCl solution to completely discharge the battery before separating the cathodic materials.

In one embodiment, the cathodic materials are separated from the spent battery by: using a knife to cut an edge of a shell of the spent battery to expose a cell of the spent battery; and separating the cathodic materials from the anodic materials in the cell.

In one embodiment, the cathodic materials are purified by putting the cathodic material into a Muffle furnace at 600 °C for 2 hours.

In one embodiment, the electrochemical catalysts are milled by a ball milling machine with ZrO₂ balls at a rotational speed of 450 rpm for 2 hours.

In one embodiment, the plasma treatment is performed with sulfur hexafluoride (SF₆) plasma.

In accordance with another aspect of the present invention, a method is provided for upcycling LiCoO₂ materials from a spent lithium-ion battery to LiCoNiFePd catalysts and using the LiCoNiFePd catalysts to construct an anode-gas diffusion layer for anion exchange membrane water electrolysis. The method comprises: separating the LiCoO₂ materials from the spent lithium-ion battery; purifying the LiCoO₂ materials; doping the LiCoO₂ materials with Ni, Fe and Pd to obtain the LiCoNiFePd catalysts; milling the LiCoNiFePd catalysts to reduce particle sizes of the LiCoNiFePd catalysts; and performing plasma treatment on the LiCoNiFePd catalysts to increase surface activities of the LiCoNiFePd catalysts; preparing an anode catalyst ink; and spray-coating the anode catalyst ink onto a nickel foam with a loading of 10 mg /cm² at a hot plate of 80 °C to form the anode-gas diffusion layer. The anode catalyst ink is prepared by: mixing the LiCoNiFePd catalysts, a sulfonated tetrafluoroethylene-based fluoropolymer-copolymer, anhydrous ethanol, and deionized water in a ratio of 1 mg:20 μL:0.5 mL:0.5 mL to form a mixture; and ultrasonicating the mixture for 1 h in an ice bath to obtain the anode catalyst ink.

This invention provides an innovative, environmentally friendly process for recycling spent battery cathode materials, which minimizes carbon emissions and chemical waste while converting these materials into high-performance, non-precious metal-based electrocatalysts for green hydrogen production. The process is scalable, enabling recycling of spent battery cathode materials and output of electrocatalysts at the kilogram scale, and is designed to be highly economical by reducing reliance on precious metals.

Moreover, the upcycled electrocatalysts could drive high-performance anion exchange membrane water electrolysis (AEMWE, cell potential 1.58V@2.5 A cm⁻²), comparable to that of proton exchange membrane water electrolysis but at substantially reduced costs. The catalysts exhibit robust performance in supporting kilowatt-scale AEMWE systems, thereby ensuring reliability for industrial applications.

The present invention further provides a complex doping method to improve the practical OER performance of recycled LCO and clarify the critical role of each doping element. By manipulating the catalyst reconstruction extent under elevated electrolysis temperatures, a high-performance LiCo_{0.79}Ni_{0.1}Fe_{0.1}Pd_{0.01}O₂ (LCNFPdO) electrocatalyst is developed with exceptional stability (over 2,000 hours) and superior activity that outperforms benchmarking catalysts.

Moreover, surface modification is performed to enable the cobalt-based electrocatalysts to have new surface properties, which are more favorable for water splitting. As a result, the present invention will have higher activity than commercial electrocatalysts. The recycling of spent LIB cathode materials for water-splitting catalysts represents a substantial opportunity for scientific and technological advancement. This innovative approach addresses two urgent issues: the sustainable management of electronic waste and the development of cost-effective electrocatalysts for water splitting. The recycling of spent LIB cathodes, which have been enriched with transition metals such as Co, Ni, and Mn, has the potential to yield active materials for the oxygen evolution reaction or the hydrogen evolution reaction. By employing techniques such as chemical leaching, heteroatom doping, and structural reconfiguration, these materials can be repurposed to enhance their catalytic performance, thereby fostering a circular economy and advancing renewable energy technologies. By integrating battery recycling with advanced hydrogen production technologies, this invention advances the concept of a circular economy while enhancing the affordability and scalability of green hydrogen, thereby addressing critical environmental and economic challenges.

### BRIEF DESCRIPTION OF THE DRAWINGS

Embodiments of the invention are described in more detail hereinafter with reference to the drawings, in which:

FIG. 1 illustrates a flowchart of a method for recycling spent lithium-ion batteries cathodic materials and upcycling them into electrocatalysts in accordance with one embodiment of the present invention.

FIG. 2 illustrates a schematic diagram of an AEMWE cell.

FIG. 3 illustrates a flowchart of a fabrication process of anode-gas diffusion layer in accordance with one embodiment of the present invention.

FIG. 4 illustrates AEMWE polarization curve at 80 ºC with working electrode area of 1 cm⁻², anode: studied catalyst, cathode: Pt/C. The solid points are the tested results by this work, and the void points are from the published literature for comparison.

FIG. 5 illustrates electrochemical impedance spectroscopy (EIS) plot at a potential of 1.8 V.

FIG. 6 illustrates stability test at a current density of 500 mA cm⁻² at 60 ºC.

### DETAILED DESCRIPTION

In the following description, details of the present invention are set forth as preferred embodiments, not intended to be adopted restrictively. It will be apparent to those skilled in the art that modifications, including additions and/or substitutions, may be made without departing from the scope and spirit of the invention. Specific details may be omitted so as not to obscure the invention; however, the disclosure is written to enable one skilled in the art to practice the teachings herein without undue experimentation.

Unless defined by something else, all technical and scientific terminologies mentioned in this description have the same meaning as commonly understood by one of ordinary skill in the art to which this invention belongs.

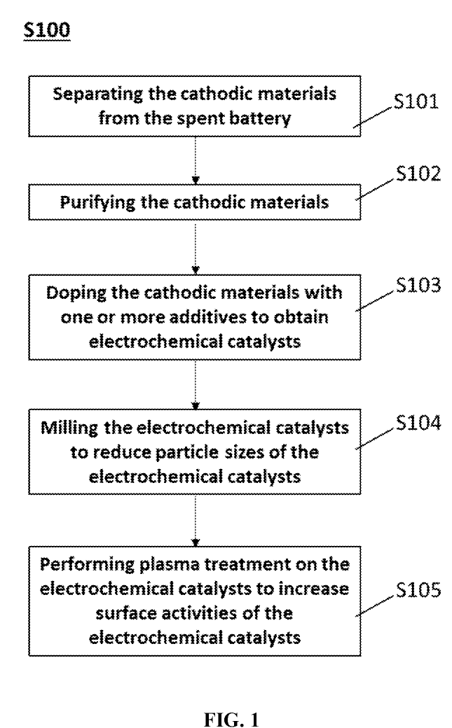

FIG. 1 illustrates a flowchart of a method S100 for recycling spent lithium-ion batteries cathodic materials and upcycling them into electrocatalysts. The method S100 comprises the following steps:

S101: separating the cathodic materials from the spent battery;

S102: purifying the cathodic materials;

S103: doping the cathodic materials with one or more additives to obtain electrochemical catalysts such as durable cobalt oxide-based OER electrocatalysts with improved electrochemical stability (e.g., to mitigate surface restructuring by suppressing cobalt redox during OER).

S104: milling the electrochemical catalysts to reduce particle sizes of the electrochemical catalysts; and

S105: performing plasma treatment on the electrochemical catalysts to increase surface activities of the electrochemical catalysts.

Before step S101, the method S100 may comprises discharging the spent lithium-ion batteries by soaking them in saturated NaCl solutions for 12 hours or until no bubbles are observed in the solutions.

In step 101, the cathodic materials are separated from the spent battery by: using a knife to cut an edge of a shell of the spent battery to expose a cell of the spent battery; and separating the cathodic materials from the anodic materials in the cell.

In step 102, the cathodic materials are purified by: putting the cathodic materials into a Muffle furnace and heat them to 600 °C for 2 hours to purify the spent cathodic materials by removing binder and conductive carbon mixed in the cathodic materials.

In step 104, the doped cathodic materials are transferred to a ball milling machine, and then milled in a ZrO₂ milling can with ZrO₂ balls at a rotational speed of 450 rpm for 2 hours. This will significantly decrease the size of cathodic materials and change the surface structure.

In step 105, the plasma treatment is performed with sulfur hexafluoride (SF₆) plasma on surface of the electrochemical catalysts to increase surface activity.

In one embodiment, the spent battery is a lithium-ion battery; and the cathodic materials are LiCoO₂ _{.} The LiCoO₂ materials are doped with Ni, Fe and Pd such that the electrochemical catalysts are LiCoNiFePd catalysts.

The obtained LiCoNiFePd catalysts have a composition of LiCo_{0.79}Ni_{0.1}Fe_{0.1}Pd_{0.01}O₂ (LCNFPdO) anda layered structure, which achieved a record OER stability of over 2,000 hours. It should be understood that other upcycled LiCoNiFePd catalysts having different Ni, Fe, and Pd compositions may also exhibit good OER stability. Through the synergistic effects of Ni, Fe, and Pd, the complex doping increases the initial cobalt valence, which creates an energy barrier that limits lithium loss and prevents the formation of thick, unstable reconstructed layers. Furthermore, the inclusion of Fe and Pd enhances electronic conductivity and accelerates gas bubble removal, boosting mechanical robustness and preventing metal leaching. Crucially, because this composition yields the highest catalytic activity, it requires the lowest overpotential during operation; this reduced energy barrier further mitigates electrochemical degradation of the catalyst structure, ensuring long-term stability.

Additionally, membrane electrolyzer tests revealed its superior anodic performance compared to the benchmark RuO₂, reaching 2.5 A cm⁻² at only 1.58 V and maintaining long-term stability for over 1,420 hours at 0.5 A cm⁻².

The doping of different elements to LiCoO₂ was achieved by mixing the LiCoO₂ and the stoichiometric oxides/salts, including Fe₂O₃ (≥99%), NiO (99%), and Pd(NO₃)₂ (0.216 M). And then the evenly mixed powders were sintered for 12 hours in ambient air with a heating ramping rate of 10 ºC min⁻¹. The thermal treatment temperature for catalyst preparation has been optimized, and 700-850 ºC is suitable for LCO, among which 800 ºC is chosen as the sintering temperature in the present invention, considering proper kinetics and high-purity phase.

The complex multi-element doping facilitates cation extraction rate tuning, which enables surface dynamic reconstruction and increases the initial Co valence through multi-element doping, thereby enhancing the OER activity of layered LCO. Furthermore, the strain induced by multi-element doping resulted in the obstruction of Li⁺ migration, thereby preventing the excessive delithiation and over-oxidation of Co at the surface. This led to the formation of a stable bulk structure and an amorphous layer with high OER activity in proximity to the surface at industrial temperatures. The strategy described herein could be potentially applied to a large family of cation inserted layered materials for redox-active kinetic tuning, for instance, layered oxides (AMO₂: A is alkaline metal; M is transition metal), spinel-type oxides (AM₂O₄: A is alkaline metal; M is transition metal), perovskite (ABO₃: A is Li or K; B is Nb or Ti), and other layered (hydro)oxides (e.g., montmorillonite).

In one practical implementation, the LCNFPdO catalysts obtained by the method S100 may be used to construct an anode-gas diffusion layer (GDL) in an AEMWE cell (FIG. 2).

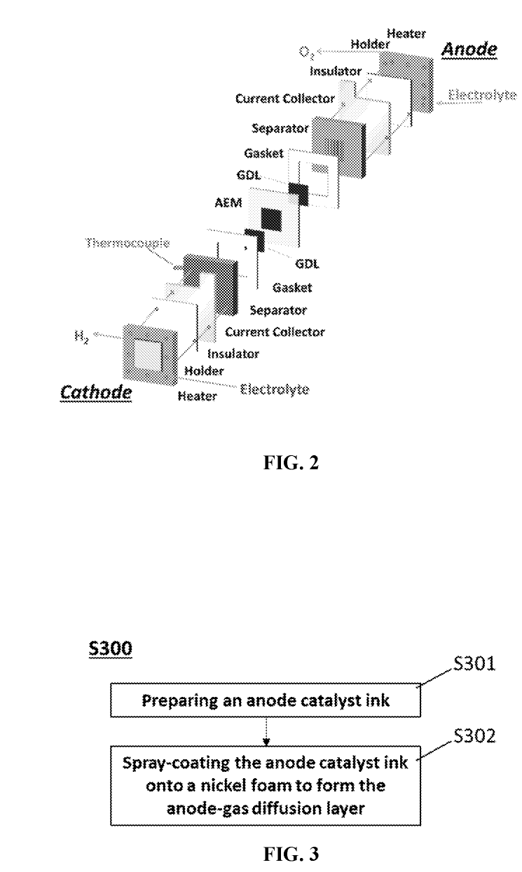

Referring to FIG. 3, the fabrication process S300 of the anode-gas diffusion layer may include the following steps:

S301: preparing an anode catalyst ink by: mixing the LiCoNiFePd catalysts, a sulfonated tetrafluoroethylene-based fluoropolymer-copolymer, anhydrous ethanol, and deionized water in a ratio of 1 mg:20 μL:0.5 mL:0.5 mL to form a mixture; and ultrasonicating the mixture for 1 h in an ice bath to obtain the anode catalyst ink; and

S302: spray-coating the anode catalyst ink onto a nickel foam with a loading of 10 mg cm⁻ ² at a hot plate of 80 °C to form the anode-gas diffusion layer.

The fabricated anode-gas diffusion layer (i.e. LCNFPdO on Ni foam) may then be used together with a cathode-gas diffusion layer (10% Pt/C on carbon paper) to sandwich the anion exchange membrane (AEM) within anode and cathode current collectors under a pressure of around 3 MPa.

The fabrication process for the cathode-gas diffusion layer is similar to the anode-gas diffusion layer except for that the LCNFPdO is replaced with commercial 10% Pt/C, and the nickel foam is replaced with a carbon paper.

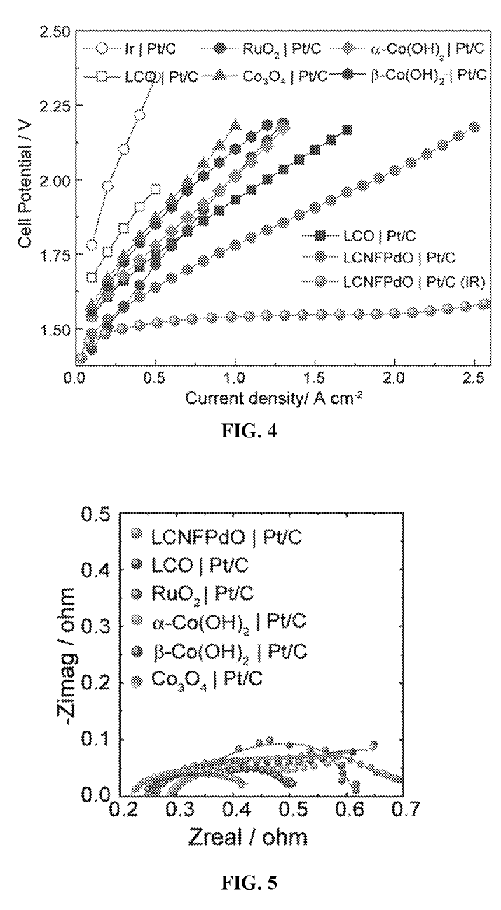

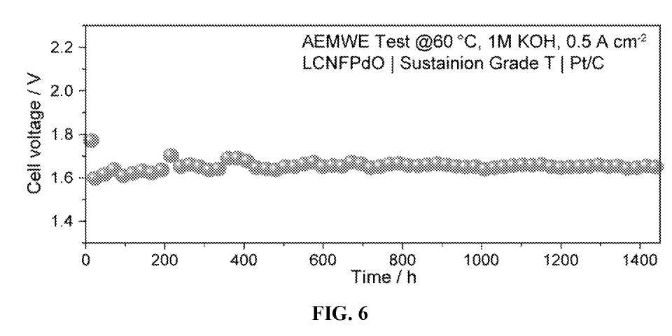

In AEMWE tests, at the same cell voltage of 2 V, LCNFPdO achieved a current density of 2 A cm⁻² (FIG. 4), much larger than those of comparative samples including RuO₂, α-Co(OH)₂, and β-Co(OH)₂. This superior performance was also accompanied by a lower polarization impedance (FIG. 5). With iR correction, LCNFPdO delivered 2.5 A cm⁻² at only 1.58 V (FIG. 4), suggesting great application potential. In addition, the AEMWE cell with LCNFPdO as the anode sustained the current density of 500 mA cm⁻² without any degradation for over 1,420 hours (FIG. 6).

In this invention, the upcycling process is streamlined, eliminating the need for intricate procedures or extensive pathways. Moreover, this methodology is not limited to spent lithium cobalt oxides; it is versatile and can be applied to a broader range of lithium-ion batteries that utilize transition metal oxides as their cathode materials.

In this invention, the embodiment offers a feasible process for recovering cathodic materials from spent lithium-ion batteries without high energy consumption and chemical wastes and an approachable process for directly upcycling these recovered materials into electrocatalysts for producing green hydrogen without too long pathways or too much cost.

While the present disclosure has been described and illustrated with reference to specific embodiments thereof, these descriptions and illustrations are not limiting. The illustrations may not necessarily be drawn to scale. There may be distinctions between the illustrations in the present disclosure and the actual apparatus due to manufacturing processes and tolerances. There may be other embodiments of the present disclosure that are not specifically illustrated. Modifications may be made to adapt a particular situation, material, composition of matter, method, or process to the objective and scope of the present disclosure. All such modifications are intended to be within the scope of the claims appended hereto. While the methods disclosed herein have been described with reference to particular operations performed in a particular order, it will be understood that these operations may be combined, subdivided, or re-ordered to form an equivalent method without departing from the teachings of the present disclosure. Accordingly, unless specifically indicated herein, the order and grouping of the operations are not limitations.

What is claimed is:

1. A method for upcycling cathodic materials from a spent battery to electrochemical catalysts, comprising:
separating the cathodic materials from the spent battery;
purifying the cathodic materials;
doping the cathodic materials with one or more additives to obtain the electrochemical catalysts;
milling the electrochemical catalysts to reduce particle sizes of the electrochemical catalysts; and
performing plasma treatment on the electrochemical catalysts to increase surface activities of the electrochemical catalysts.

2. The method according to claim 1, wherein the spent battery is a lithium-ion battery; and the cathodic materials are LiCoO₂_{.}

3. The method according to claim 2, further comprising doping the LiCoO₂ materials with Ni, Fe and Pd such that the electrochemical catalysts are LiCoNiFePd catalysts.

4. The method according to claim 3, wherein doping the LiCoO₂ materials with Ni, Fe and Pd comprises: mixing the LiCoO₂ materials with Fe₂O₃_{,} NiO and Pd(NO₃)₂to form a mixture; and sintering the mixture in ambient air to form the LiCoNiFePd catalysts.

5. The method according to claim 4, wherein sintering the mixture is performed by heating the mixture from ambient temperature to a sintering temperature with a heating ramping rate in a range of 5 to 10 ºC min⁻¹ and the sintering temperature is in a range of 700 to 850 ºC such that the LiCoNiFePd catalyst has a composition of LiCo_{0.79}Ni_{0.1}Fe_{0.1}Pd_{0.01}O₂ anda layered structure.

6. The method according to claim 1, further comprising soaking the spent battery in a saturated NaCl solution to completely discharge the battery before separating the cathodic materials.

7. The method according to claim 1, wherein separating the cathodic materials from the spent battery comprises: using a knife to cut an edge of a shell of the spent battery to expose a cell of the spent battery; and separating the cathodic materials from the anodic materials in the cell.

8. The method according to claim 1, wherein the cathodic materials are purified by putting the cathodic material into a Muffle furnace at 600 °C for 2 hours.

9. The method according to claim 1, wherein milling the electrochemical catalysts comprises milling the electrochemical catalysts by a ball milling machine with ZrO₂ balls at a rotational speed of 450 rpm for 2 hours.

10. The method according to claim 1, wherein the plasma treatment is performed with sulfur hexafluoride (SF₆) plasma.

11. A method for upcycling LiCoO₂ materials from a spent lithium-ion battery to LiCoNiFePd catalysts and using the LiCoNiFePd catalysts to construct an anode-gas diffusion layer for anion exchange membrane water electrolysis, the method comprises:
separating the LiCoO₂ materials from the spent lithium-ion battery;
purifying the LiCoO₂ materials;
doping the LiCoO₂ materials with Ni, Fe and Pd to obtain the LiCoNiFePd catalysts;
milling the LiCoNiFePd catalysts to reduce particle sizes of the LiCoNiFePd catalysts; and
performing plasma treatment on the LiCoNiFePd catalysts to increase surface activities of the LiCoNiFePd catalysts;
preparing an anode catalyst ink by:
mixing the LiCoNiFePd catalysts, a sulfonated tetrafluoroethylene-based fluoropolymer-copolymer, anhydrous ethanol, and deionized water in a ratio of 1 mg:20 μL:0.5 mL:0.5 mL to form a mixture; and
ultrasonicating the mixture for 1 h in an ice bath to obtain the anode catalyst ink; and
spray-coating the anode catalyst ink onto a nickel foam with a loading of 10 mg/cm² at a hot plate of 80 °C to form the anode-gas diffusion layer.

12. The method according to claim 11, wherein the LiCoO₂ materials are doped with Ni, Fe and Pd by: mixing the LiCoO₂ materials with Fe₂O₃_{,} NiO and Pd(NO₃)₂to form a mixture; and sintering the mixture in ambient air to form the LiCoNiFePd catalysts.

13. The method according to claim 12, wherein sintering the mixture is performed by heating the mixture from ambient temperature to a sintering temperature with a heating ramping rate in a range of 5 to 10 ºC min⁻¹ and the sintering temperature is in a range of 700 to 850 ºC such that the LiCoNiFePd catalyst has a composition of LiCo_{0.79}Ni_{0.1}Fe_{0.1}Pd_{0.01}O₂ anda layered structure.

14. The method according to claim 11, wherein the cathodic materials are separated from the spent battery by: using a knife to cut an edge of a shell of the spent battery to expose a cell of the spent battery; and separating the cathodic materials from the anodic materials in the cell.

15. The method according to claim 11, wherein the LiCoO₂ materials are purified by putting the LiCoO₂ materials into a Muffle furnace at 600 °C for 2 hours.

16. The method according to claim 11, wherein the LiCoNiFePd catalysts are milled by a ball milling machine with ZrO₂ balls at a rotational speed of 450 rpm for 2 hours.

17. The method according to claim 11, wherein the plasma treatment is performed with sulfur hexafluoride (SF₆) plasma.
